(19) United States
(12) Patent Application Publication
(10) Pub. No.: US 2025/0314095 A1
(43) Pub. Date: Oct. 9, 2025

(54) ANTI-TECHNICAL UNLOCKING PINBALL LOCK CYLINDER SET

(71) Applicant: U-TEC GROUP INC., Union City, CA (US)

(72) Inventor: Lingling QIAN, Union City, CA (US)

(73) Assignee: U-TEC GROUP INC., Union City, CA (US)

(21) Appl. No.: 18/630,001

(22) Filed: Apr. 9, 2024

(51) Int. Cl. E05B 27/08

(52) U.S. Cl. CPC E05B 27/083

(57) ABSTRACT

The present invention relates to the technical field of locks, and specifically to an anti-technical unlocking pinball lock cylinder set, comprising a lock shell and a lock cylinder arranged in the lock shell, wherein inside the lock cylinder are provided lower pinball cavities, inside the lock shell are provided upper pinball cavities, above upper pinballs are provided springs, above the springs is provided a cover plate, the lower pinball cavities comprise at least one shallow cavity, inside the at least one shallow cavity is provided at least one short lower pinball, upper pinballs comprise at least one stainless steel upper pinball which forms at least one stainless steel pinball set with at least one stainless steel lower pinball corresponding to same positions below, and remaining upper pinballs which are special-shaped upper pinballs. The present invention improves structures of internal cavities and upper and lower pinballs, so as to avoid the risk of using various tools to unlock, improve the reliability and value of the lock, and provide protection for people's property and personal safety.

### TECHNICAL FIELD

The present invention relates to the technical field of locks, and specifically to an anti-technical unlocking pinball lock cylinder set.

### BACKGROUND TECHNOLOGY

Locks have a long history, but core unlocking mechanisms of locks have almost been the same, i.e., when right keys are inserted into lock cylinders, teeth on the keys interact with pinballs and springs inside the lock cylinders, allowing the lock cylinders to rotate. With the advancement and improvement of the technology, locking and unlocking principles have been indeed improved at different stages. For example, in a pinball tumbler lock, there are multiple springs and sets of pinballs inside a lock core, and the pinballs are designed to block holes inside the lock core when the lock cylinder is not rotated. Only when a right key is inserted and corresponding pinballs are aligned by pushing, can the lock cylinder rotate.

Pinball locks in the prior art can usually be unlocked by using vibrating tools, master keys, simple torsion bars, wavy rods, etc., which poses a challenge to the safety of pinball locks, and further affects property and personal safety.

Based on the above reasons, the present invention has designed an anti-technical unlocking pinball lock cylinder set, in which an internal structure of a pinball lock is improved so as to avoid the problem of using various existing tools to unlock, improve the reliability of the lock, and assist for the protection of individuals and property.

### SUMMARY OF THE INVENTION

The present invention aims to overcome technical defects above and provides a pinball lock cylinder set, in which an internal structure of a pinball lock is improved so as to avoid the problem of using various existing tools to unlock, improve the reliability of the lock, and provide help for the safety of people and property.

The present invention provides an anti-technical unlocking pinball lock cylinder set, comprising a lock shell and a lock cylinder arranged in the lock shell, wherein inside the lock cylinder are provided lower pinball cavities, inside the lock shell are provided upper pinball cavities, above upper pinballs are provided springs, above the springs is provided a cover plate, the lower pinball cavities comprise at least one shallow cavity, inside the at least one shallow cavity is provided at least one short lower pinball, upper pinballs comprise at least one stainless steel upper pinball, wherein the at least one stainless steel upper pinball and at least one stainless steel lower pinball corresponding to the at least one stainless steel upper pinball form at least one stainless steel pinball set, and remaining upper pinballs which are irregular upper pinballs.

The irregular upper pinballs comprise I-shapes, mushroom-shapes or other irregular shapes.

Compared with existing technology, the present invention designs a set of corresponding upper and lower pinballs made of stainless steel, whose strength and composition allow them to rotate within cavities, to increase the difficulty for drilling tools (such as electric drills) to penetrate them; additionally, one of the lower pinballs is designed as a short pinball placed in a shallow cavity, preventing bypass tools (bump keys) from reaching the short pinball and thus increasing the complexity of unlocking; furthermore, the remaining upper pinballs are designed as special-shaped pinballs, so that when unlocking tools such as single hooks or brush hooks are unlocked, the special-shaped pins and the lock cylinder are stuck, and the rotation angle of the lock cylinder is reduced as much as possible, so that the lock cylinder cannot rotate and the lock cannot be unlocked.

### BRIEF DESCRIPTION OF THE DRAWINGS

FIG. 1 is an explosion schematic diagram of the present invention.

FIG. 2 is a schematic diagram of internal components of the present invention.

FIG. 3 is a schematic diagram showing internal anti-collision design of the present invention.

FIG. 4 is a schematic diagram of anti-single hook brush hooks of internal upper pinballs of the present invention.

The markups in the drawings are indicated as follows:
1—lock cylinder;
2—spring;
3—stainless steel pinball set;
4—special-shaped upper pinball;
401—stainless steel upper pinball;
5—lower pinball;
501—short lower pinball;
502—stainless steel lower pinball;
6—lock shell; and
7—cover plate.

### SPECIFIC EMBODIMENTS

The present invention is further described in conjunction with the attached drawings.

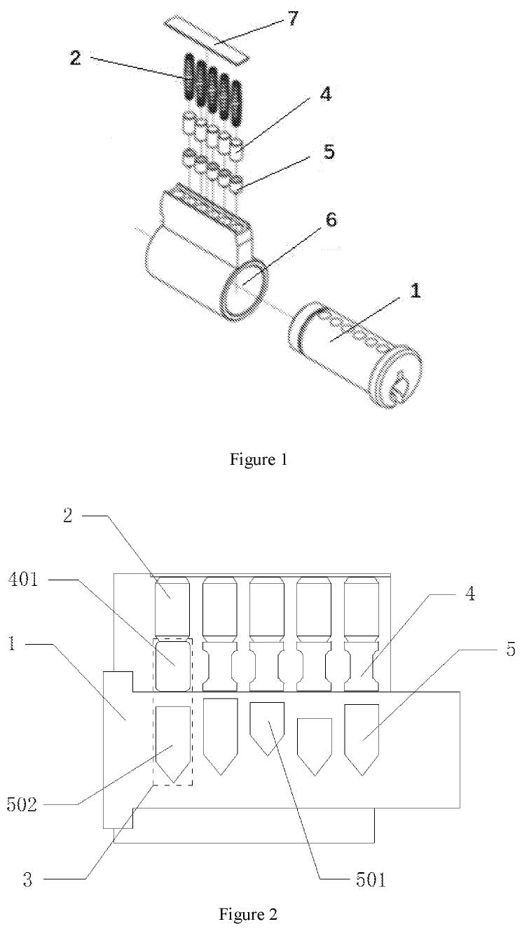

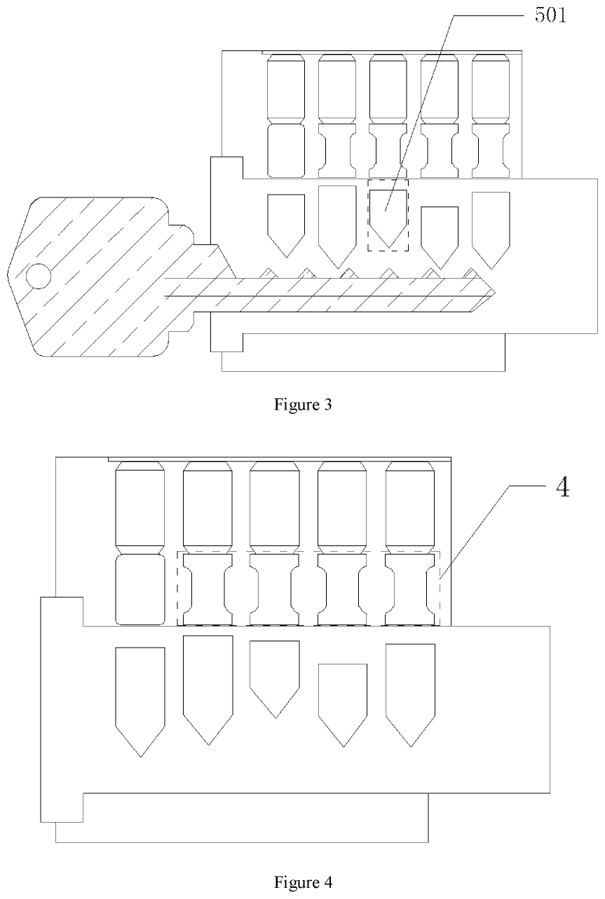

As shown in FIGS. 1-4, the present invention provides an anti-technical unlocking pinball lock cylinder set, comprising:
a lock shell 6 and a lock cylinder 1 arranged in the lock shell 6, wherein inside the lock cylinder 1 are provided lower pinball cavities, inside the lock shell 1 are provided upper pinball cavities, above upper pinballs are provided springs 2, above the springs 2 is provided a cover plate 7, inside the lower pinball cavities comprise at least one shallow cavity, inside the at least one shallow cavity is provided at least one short lower pinball 501, upper pinballs comprise at least one stainless steel upper pinball 401 which forms at least one stainless steel pinball set 3 with at least one stainless steel lower pinball 502 corresponding to same positions below, and remaining upper pinballs which are special-shaped upper pinballs 4.

The special-shaped upper pinballs 4 comprise I-shapes, mushroom-shapes or other special shapes.

### Working Principle

The working principle of the present invention is simple, an upper row of upper pinballs comprise the stainless steel upper pinball 401 and a plurality of the special-shaped upper pinballs 4, and a lower row of lower pinballs comprises a stainless steel lower pin 502, a short lower pin 501 and general lower pinballs 5. When one uses an electric drill to pierce the lock cylinder set, due to the existence of the stainless steel pinball set 3, an electric drill bit touches the stainless steel upper pin 401 and the corresponding stainless steel lower pin 502 to force it, due to the relationship of its material strength, the stainless steel upper pin 401 and the stainless steel lower pin 502 will follow the drill to rotate, preventing the drill from further advancing. When one uses a master key or bumper to unlock, since the lock cylinder 1 comprises the at least one shallow cavity and the at least one short lower pinball 501 inside, at this time, a height of the master key or the bumper cannot touch the at least one short pinball 501 in the at least one shallow cavity, and then the lifting operation cannot be performed, which further increases the difficulty of unlocking. Furthermore, even if the lower pinballs are pushed up, due to the presence of the plurality of special-shaped upper pinballs 4, when the lock cylinder 1 attempts to be rotated, a slotted structure thereof enables it to be blocked by the upper and lower pinballs at tangential positions when received downward pressing forces of the springs 2, the lock cylinder 1 will not be pushed up or separated from the tangential positions even if it is vibrated up and down at this time, and the existence of the plurality of special-shaped upper pins 4 can greatly reduce the degree of rotation of the lock cylinder 1, even if there is one special-shaped upper pin 4 is pushed up, the rest pinballs can still be firmly stuck on the lock cylinder 1. Therefore, the present invention integrates the stainless steel pinball set 3, and cooperates with functions of the at least one short lower pinball 501 in the at least one shallow cavity and the plurality of special-shaped upper pins 4, which greatly improves the difficulty of unlocking and ensures the safety of the lock.

The above are only some preferred embodiments of the present invention, and are only used to help understand the method of the present invention and core idea thereof. The scope of protection of the present invention is not limited to the above embodiments, and all technical solutions belonging to the idea of the present invention belong to the scope of protection of the present invention. It should be noted that for ordinary technicians in the technical field, certain improvements and refinements that are not divorced from the principle of the present invention shall also be considered as falling into the scope of protection of the present invention.

The present invention solves the problem that various simple tools can be used to unlock pinball locks in the prior art, and avoids the risk of unlocking with various tools by improving structures of the internal cavity and the upper and lower pinballs, which improves the reliability and value of the lock, and provides protection for people's property and personal safety.

1. An anti-technical unlocking pinball lock cylinder set, comprising a lock shell (6) and a lock cylinder (1) arranged in the lock shell (6), wherein inside the lock cylinder (1) are provided lower pinball cavities, inside the lock shell (1) are provided upper pinball cavities, above upper pinballs are provided springs (2), above the springs (2) is provided a cover plate (7), the lower pinball cavities comprise at least one shallow cavity, inside the at least one shallow cavity is provided at least one short lower pinball (501), upper pinballs comprise at least one stainless steel upper pinball (401), wherein the at least one stainless steel upper pinball (401) and at least one lower stainless steel pinball (502) underneath the at least one upper stainless steel upper pinball (402) form at least one stainless steel pinball set (3), and remaining upper pinballs are irregular upper pinballs (4).

2. The anti-technical unlocking pinball lock cylinder set according to claim 1, wherein the irregular upper pinballs (4) comprise I-shapes, mushroom-shapes or other irregular shapes.
